(19) United States
(12) Patent Application Publication
(10) Pub. No.: US 2002/0053113 A1
(43) Pub. Date: May 9, 2002

(54) Windshield wiper

(76) Inventors: Xavier Boland, Arlon (BE); Gurdev Orjela, Arlon (BE); Gerald Roussel, Saint-Vincent (BE)

Correspondence Address: Robert L. Stearns, 5291 Colony Drive North, Saginaw, MI, 48603, US

(21) Appl. No.: 09/981,115

(22) Filed: Oct. 17, 2001

(30) Foreign Application Priority Data
Oct. 23, 2000 (EP) 00203674.7

(51) Int. Cl. B60S 1/38

(52) U.S. Cl. 15/250.48; 15/245

(57) ABSTRACT

Windshield wiper comprising an oscillating arm and a frame connected thereto for receiving a wiper blade, wherein the wiper blade comprises a body portion and a downwardly extending wiping lip for wiping the upper surface of a windshield, said wiping lip being connected to said body portion through two connecting pieces at least partially surrounding a hollow space, seen in cross-section, characterized in that said connecting pieces are at least substantially straight.

The invention relates to windshield wiper comprising an oscillating arm and a frame connected thereto for receiving a wiper blade, wherein the wiper blade comprises a body portion and a downwardly extending wiping lip for wiping the upper surface of a windshield, said wiping lip being connected to said body portion through two connecting pieces at least partially surrounding a hollow space, seen in cross-section. The invention also refers to a wiper blade suitable for use in a windshield wiper according to the invention.

Such a windshield wiper is known from German patent publication no. 198.27.032 in the name of Asmo Co. Deformation of the T-shaped hollow space extending vertically from the main portion of this known windshield wiper to the wiping lip thereof prevents differences in height of the windshield wiper due to reversal of (the angle of inclination of) the wiping lip during its wiping action, whilst said deformation ensures a suitable angle of inclination at all times.

A drawback of the windscreen wiper as known from the above German patent document is that each connecting piece thereof is severely bent and therefore charged with pressure and tension loads during a wiping action, resulting in high stresses in the surface of each connecting piece: ultimately, the resistance against environmental influences, such as high temperatures, temperature changes, ozone and/or UV radiation, for example, will deteriorate and ageing will ensue. A further drawback is that dust, snow, ice etcetera can penetrate into the small grooves between the body portion and the wiping lip of this known windshield wiper, causing blocking of the wiping action of the wiping lip and thus malfunction of said windshield wiper. Finally, it has become apparent in practice that reversal of (the angle of inclination of) the wiping lip during its wiping action takes more time than anticipated, with all its disadvantages involved.

It is the object of the invention to provide a windscreen wiper wherein the aforesaid drawbacks of the prior art are overcome, that is, wherein an effective windscreen wiper is provided that is resistant against all kind of weather influences, such as (high) temperatures (changes) and ice/snow. In order to accomplish that objective, a windscreen wiper of the kind referred to in the preamble is characterized in that said connecting pieces are at least substantially straight. Consequently, the connecting pieces will not be forced to a bending operation, wherein, during a wiping action, one of said connecting pieces is charged (at least substantially) with a pressure load in its longitudinal direction and the other connecting piece is charged (at least substantially) with a tension load in its longitudinal direction, and vice versa, when the wining action is reversed. All this results in reduced surface tensions in both connecting pieces and thus in an extended life of the wiper blade.

It is noted that the invention also relates to a windscreen wiper wherein the oscillating arm and the frame are constructed as one part. The invention is not restricted to use with passenger cars for that matter, but it can also be used with trains and other (fast) vehicles.

In one preferred embodiment of a windscreen wiper according to the invention, said connecting pieces have a width varying between 0.1 mm and 0.4 mm, preferably between 0.2 mm and 0.3 mm.

In another preferred embodiment of a windscreen wiper according to the invention, said connecting pieces enclose an internal angle varying between 15° and 90°, preferably between 30° and 60°.

In another preferred embodiment of a windscreen wiper according to the invention, the hollow space has a cross-section that is at least substantially circular, elliptical, triangular or T-shaped.

The invention will be explained in more detail hereafter with reference to figures illustrated in a drawing, wherein

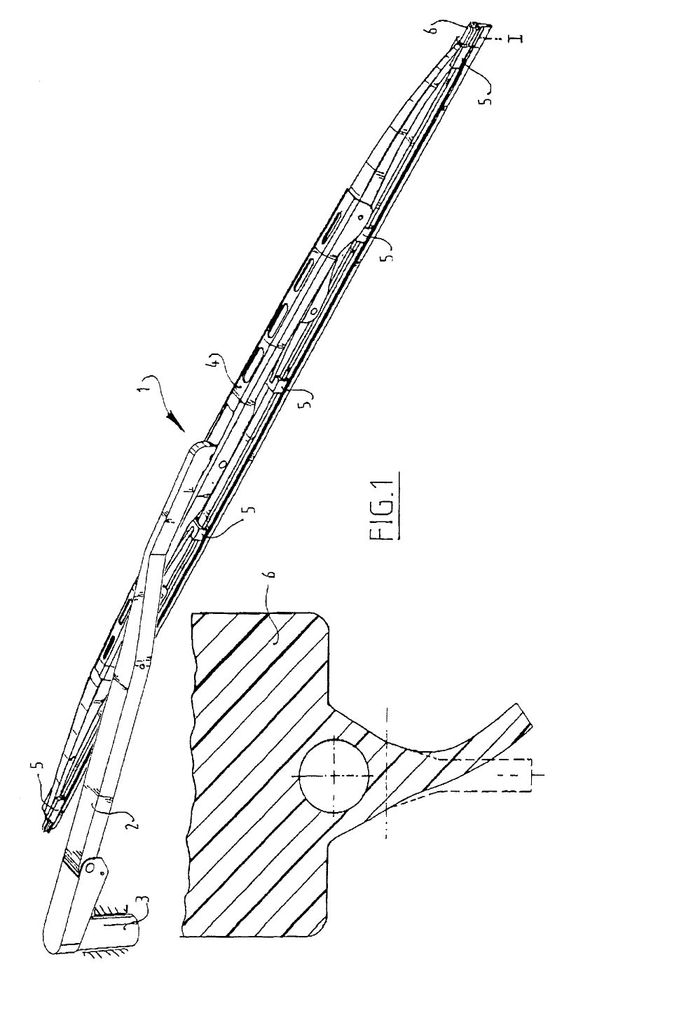

FIG. 1 is a perspective view of a windshield wiper according to the invention;

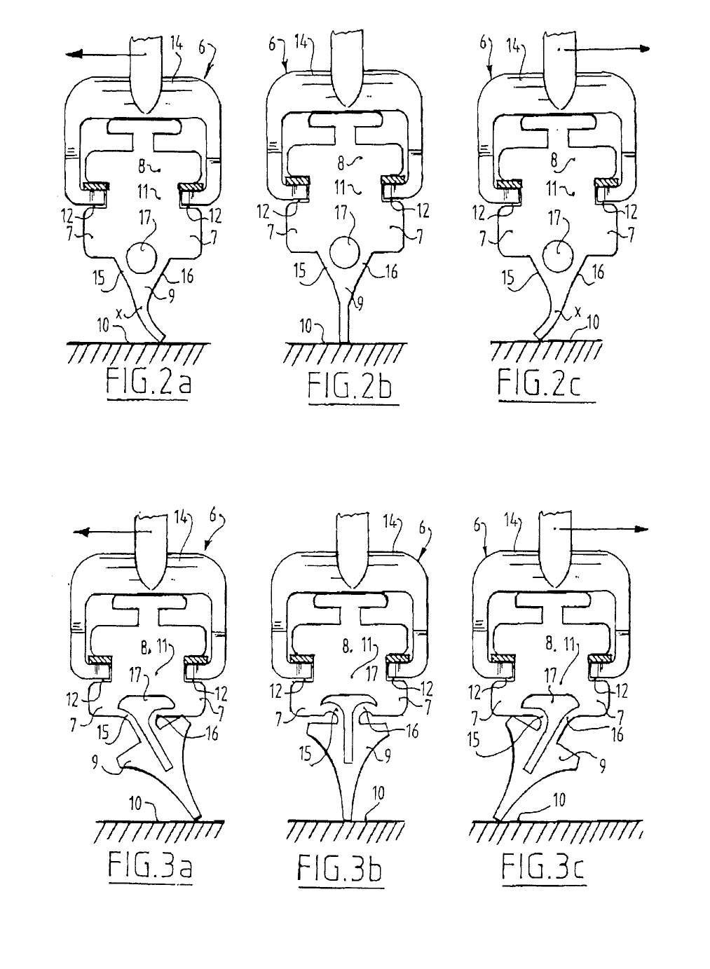

FIG. 2 is an enlarged and elevational view showing an embodiment of a wiper blade in accordance with the invention during a wiping action in one direction (FIG. 2a), in reversed direction (FIG. 2c), ad well as in relaxed position (FIG. 2b); and

FIG. 3 corresponds to FIG. 2, with its difference that it relates to an embodiment of a prior art wiper blade.

FIG. 1 shows a perspective view of a windshield wiper 1 according to the invention, representing an oscillating arm 2 mounted on a mounting head 3, as well as a frame 4 connected to the oscillating arm 2 and having several claws 5 for receiving an elongate wiper blade or squeegee 6. The wiper blade 6 is shown in cross-section on the left in FIG. 1 in relaxed position (dashed lines) and in wiping position full lines, as will be elucidated further with the help of FIG. 3. The wiper blade 6 has a uniform cross-section and is preferably extruded from an elastomeric material. The term “elastomeric material” is understood to include natural rubber and natural rubber compositions, as well as synthetic polymers and compositions having rubber-like properties, such as butyl rubber, polyurethane rubber, silicone rubber and the like. The wiper blade 1 is integrally formed from such an elastomeric material.

The wiper blade 6 in accordance with the invention as shown in FIG. 2 has a main body portion 7, a mounting portion 8, as well as a wiping lip 9 for wiping the upper surface 10 of a windscreen of a vehicle. The mounting portion 8 is defined by a restricted neck 11 between longitudinal grooves 12 at opposite sides of the mounting portion 8, and by an enlarged head 13 above the grooves 12. The lower edges of the grooves 12 provide shoulders, while the grooves 12 are adapted to receive mounting elements, such as claws 14, of the conventional wiper blade superstructure, which therefore need not to be referred to in detail here. Said downwardly extending wiping lip 9 is connected to said main body portion 7 through two connecting pieces 15,16 at least partially surrounding a hollow space 17, all seen in cross-section. The connecting pieces 15,16 are at least substantially straight, i.e. are not forced to bend at any time during operation of the wiper blade 6. During a wiping action said connecting pieces 15,16 are able to absorb pressure or tension loads in their longitudinal direction d1 and d2, respectively, depending on the wiping direction under the influence of right and left oscillating forces, without being forced to bend, as will be explained further with the help of FIGS. 2a and 2b.

FIG. 2a shows a position of the wiper blade 6 in one wiping direction indicated with an arrow, under influence of a left oscillating force, for example. As shown, said connecting piece 15 is not forced to a bending operation, while it is only loaded with a tension load in its longitudinal direction d1. At the same time the other connecting piece 16 is only loaded with a pression load in its longitudinal direction d2, not being forced to bend either. FIG. 2c shows a position of the wiper blade 6 in the other wiping direction again indicated with an arrow, when a right oscillating force is applied, for example. Again both connecting pieces 15,16 are straight, whilst a pressure load is exerted on connecting piece 15 in its longitudinal direction d1 and a tension load is exerted on the connecting piece 16 in its longitudinal direction d2, in accordance with the invention the major hinge point for the wiping lip 6 is located at position X below the hollow space 17 and the connecting pieces 15,16. As both connecting pieces 15,16 remain straight at all times during operation of the wiper blade 6, no small grooves between the body portion 7 and the wiping lip 9 are formed: the smooth outer surfaces of said connecting pieces 15,16 will prevent dirt, ice or snow etcetera from accumulating between said body portion 7 and the wiping lip 9, so that the wiper blade 6 is not blocked thereby during its wiping actions. FIG. 2b shows the wiper blade 6 in relaxed position, without any oscillating forces being applied thereon.

FIGS. 3a, 3b, 3c correspond with FIG. 2a, 2b, 2c, respectively, on the understanding that FIG. 3 refers to an embodiment of a wiper blade according to German patent applciation no. 198.27.032 mentioned earlier, wherein corresponding reference numerals have been used. As can be seen from FIG. 3a, during a wiping action under influence of a left oscillating force, the inner surface of the connecting piece 15 facing towards the hollow space 17 is loaded with a pressure load, whereas the outer surface thereof facing away from the hollow space 17 is loaded with a tension load. Simultaneously, the inner surface of the connecting piece 15 facing towards the hollow space 17 is loaded with a tension load, and its cuter surface facing away from the hollow space 17 is loaded with a pressure load. This all leads to high stresses in the surface material of both connecting pieces 15,16 thereby deteriorating the rubber quality. FIG. 3c refers to the other situation where as right oscillating force is applied on this prior art wiper blade 6. In FIG. 3b the known wiper blade 6 is shown in relaxed position.

The invention being thus described, it will be obvious that the same may be varied in many ways. Such variations are not to be regarded as a departure from the spirit and scope of the invention, and all such modifications as would be obvious to one skilled in the art are intended to be included in the scope of the appended claims.

1. Windshield wiper comprising an oscillating arm and a frame connected thereto for receiving a wiper blade, wherein the wiper blade comprises a body portion and a downwardly extending wiping lip for wiping the upper surface of a windshield, said wiping lip being connected to said body portion through two connecting pieces at least partially surrounding a hollow space, seen in cross-section, characterized in that said connecting pieces are at least substantially straight.

2. Windshield wiper according to claim 1, wherein said connecting pieces have a width varying between 0.1 mm and 0.4 mm, preferably between 0.2 mm and 0.3 mm.

3. Windshield wiper according to claim 1 or 2, wherein said connecting pieces enclose an internal angle varying between 15° and 90°, preferably between 30° and 60°.

4. Windshield wiper according to claim 1, 2 or 3, wherein the hollow space has a cross-section that is at least substantially circular, elliptical, triangular or T-shaped.

5. Wiper blade as defined in a windshield wiper according to any of the preceding claims 1-4.
